(19) United States
(12) Patent Application Publication
(10) Pub. No.: US 2026/0057270 A1
(43) Pub. Date: Feb. 26, 2026

(54) METHOD OF OPERATING A QUANTUM SYSTEM

(71) Applicants: SOCPRA SCIENCES ET GÉNIE S.E.C., Sherbrooke (CA); CENTRE NATIONAL DE LA RECHERCHE SCIENTIFIQUE, Paris (FR); ECOLE NORMALE SUPERIEURE DE LYON, Lyon (FR)

(72) Inventors: Cristobal Lledo Veloso, Sherbrooke (CA); Adrian Moulinas, Peypin (FR); Joachim Cohen, Nantes (FR); Alexandre Blais, Quebec (CA); Remy Dassonneville, Marseille (FR); Audrey Bienfait, Lyon (FR); Benjamin Huard, Lyon (FR); Ross Shillito, Sherbrooke (CA)

(21) Appl. No.: 18/998,072

(22) PCT Filed: Jul. 26, 2023
(86) PCT No.: PCT/EP2023/070765

§ 371 Date: Jan. 23, 2025

Related U.S. Application Data
(60) Provisional application No. 63/392,532, filed on Jul. 27, 2022.

(51) Int. Cl. G06N 10/20

(52) U.S. Cl. CPC G06N 10/20

(57) ABSTRACT

The method can be applied to a quantum system having a non-linear element coupled to a resonator, the non-linear element having a quantum state changeable between a plurality of quantum states and the resonator having a resonance frequency. The method can include driving the resonator; the resonator resonating at a first frequency in response to said driving the resonator; and simultaneously to said driving the resonator, driving the non-linear element at the first frequency.

### BACKGROUND

Quantum systems have received significant research and development interest and activity in the last years and are expected to become more and more mainstream within the next decades. A lot of this new interest is tied to the immense potential of the technology, in particular in relation with quantum computing and computer/communication security, but also in relation with other significant areas of interest. Many quantum systems involve a plurality of quantum subsystems which are coupled to one another, and in many cases, each quantum subsystem will have at least one non-linear element coupled to at least one resonator, and associated drives. Many quantum systems use two or more quantum subsystems interconnected by a coupler, and many of the latter type of quantum system can be scaled by adding additional couplers and quantum subsystems, which is the case, for instance, in gate-based quantum computers where the quantum subsystems are qubits each having two eigenstates. Other applications of the latter type of quantum system can be a quantum communications router, for instance. The quantum subsystems can have more than two eigenstates in some cases.

The exact nature of the quantum subsystems and of the couplers will vary depending on the type of quantum architectures in which they are implemented. Various architectures have been developed in recent years, such as superconducting circuits, trapped ions, photonic, etc. The general idea, irrespective of the architecture, and specific application, is to generate a quantum interaction such as entanglement or disentanglement between the eigenstates of the coupled quantum subsystems in a controlled manner, which can be done using one or more drive and via the eigenstates of couplers associated to elements of the quantum system. Quantum interaction control can implicitly involve two aspects, or facets: stimulating the interaction on demand, and avoiding undesired interactions from spontaneously occurring due to quantum effects. Depending on the architecture, it can be easier, or harder, to stimulate the controlled quantum interaction, and in architectures where stimulating the controlled quantum interaction is easier, the question of avoiding undesired interaction is typically more challenging. Increasing the speed of interactions is also an omnipresent concern.

While existing quantum systems were satisfactory to a certain degree, there always remains room for improvement.

### SUMMARY

In some quantum systems, the non-linear element playing, for example, the role of qubit, has a quantum state changeable between a plurality of quantum states and the resonator has a resonance frequency.

There is provided a method which can be used to load one, or more, non-linear element of a quantum system. The method can involve driving the resonator, to which the resonator responds at one or more frequency; and driving the non-linear element at one or more of the one or more frequency at which the resonator responds. Driving the non-linear element in this manner can cause the effect of virtually presenting the non-linear element with an empty resonator, independently of an actual loading of the resonator, which can have various uses in a variety of contexts.

In accordance with one aspect, there is provided a method of operating a quantum system having a non-linear element coupled to a resonator, the non-linear element having a quantum state changeable between a plurality of quantum states and the resonator having a resonance frequency which shifts by a difference of frequency values, the difference of frequency values depending on the quantum state of the non-linear element, the method comprising: driving the resonator; the resonator resonating at a first frequency in response to said driving the resonator; and simultaneously to said driving the resonator, driving the non-linear element at the first frequency.

In accordance with one aspect, there is provided a method of operating a quantum system having a non-linear element coupled to a resonator, the non-linear element having a quantum state changeable between a plurality of quantum states and the resonator having a resonance frequency which shifts by a difference of frequency values, the difference of frequency values depending on the quantum state of the non-linear element, the method comprising: driving the resonator; the resonator responding at a combination of its resonance frequency and the driving frequency; and simultaneously to said driving the resonator, driving the non-linear element at the two frequencies.

Many further features and combinations thereof concerning the present improvements will appear to those skilled in the art following a reading of the instant disclosure.

### DESCRIPTION OF THE FIGURES

In the figures,

FIG. 1 is a block diagram schematizing a quantum system;

FIG. 2 presents numerical simulation confirming cancelation of AC Stark shift and AC Stark-induced dephasing;

FIG. 3 illustrates a first example calibration technique with an experimental demonstration using a superconducting circuit;

FIG. 4 illustrates a second example calibration technique with an experimental demonstration using a superconducting circuit;

FIG. 5 is a graph presenting steady-state photon number as a function of X gate error resulting of an example process of controlling the non-linear element while the resonator is loaded and the cancelation drive is being applied in an experimental setup using a superconducting circuit;

FIG. 6 presents an example of qubit readout acceleration, showing numerical simulation results and an experimental demonstration with an experimental setup using a superconducting circuit;

FIG. 7 presents numerical simulations illustrating the preparation of non-Gaussian states in the resonator;

FIG. 8 is an representation of an experimental setup demonstrating operability;

FIG. 9 presents an example implementation scheme with superconducting qubits and electromagnetic resonators;

FIG. 10 presents an example implementation scheme with spin qubits embodied as quantum dots in a semiconductor, and electromagnetic resonators; and

FIG. 11 presents an example of a quantum system which includes a plurality of quantum subsystems and is embodied as a quantum computer.

### DETAILED DESCRIPTION

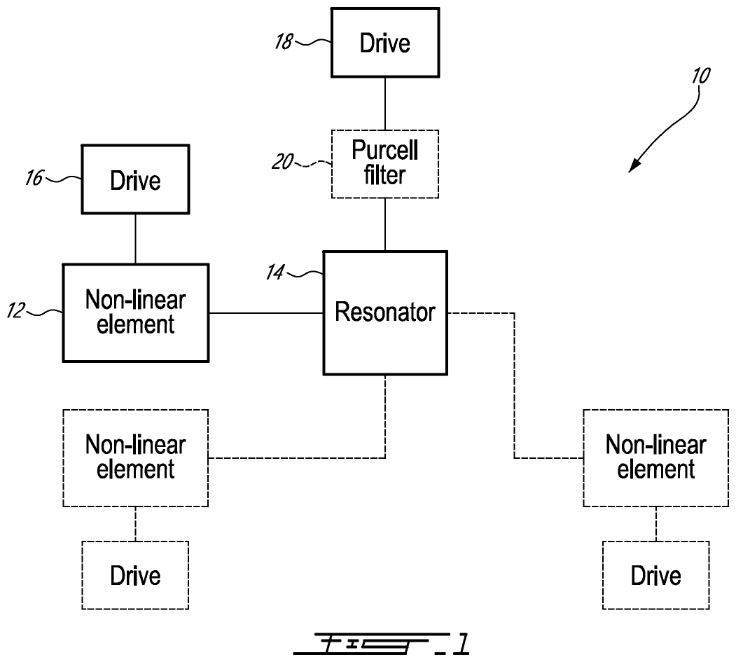

FIG. 1 shows an example of a quantum system 10 having a non-linear element 12 coupled to a resonator 14. The non-linear element 12 has a quantum state changeable between a plurality of quantum states and the resonator has a resonance frequency. In some embodiments, the resonance frequency may be affected by the quantum state of the non-linear element. More specifically, the resonance frequency of the resonator can shift by a difference of frequency values due to the presence of the non-linear element, and the difference of frequency values can be different for different ones of the plurality of quantum states. In some other embodiments, the quantum state of the resonator may be independent of the quantum state of the non-linear element, in which case the resonance frequency may not be affected by the quantum state of the non-linear element and not shift due to the presence of the non-linear element. There can be more than one non-linear element coupled to the resonator, and the quantum states can be joint quantum states of different ones of the non-linear elements.

There is provided a method which can be used to stabilize one, or more, of the non-linear elements of the quantum system 10. The method can involve driving the resonator 14, to which the resonator 14 responds at one or more frequency; and driving the non-linear element 12 at one or more of the one or more frequency at which the resonator 14 responds. “Driving” involves exposing to a coherent wave, and can be performed using distinct drives 16, 18 for distinct components, or, in some embodiments, the same drive for the non-linear element 12 and the resonator 14. For simplicity, the driving of the non-linear element 12 in this manner, i.e. at one or more of the one or more frequency at which the resonator 14 responds, can be referred to herein as the “cancelation drive” for reasons which will be apparent in light of the following specifications.

Typically, the resonator 14 is driven at a drive frequency, and responds at a combination of its resonance frequency (e.g. its natural resonance frequency) and the driving frequency, in which case the non-linear element 12 can be driven at both the drive frequency and the resonance frequency. However, in some cases, the drive frequency can be relatively close to the resonance frequency, and driving the non-linear element 12 at a central frequency which is close, or intermediary, to the central frequencies of the drive frequency and the resonance frequency can constitute a suitable approximation. Two frequencies can be considered “close” when they are within 10 resonator linewidths, within 5 resonator linewidths, or within 3 resonator linewidths for instance. When any two or more frequencies are close, they can be considered in the context of this specification as the same frequency. Accordingly, either one, or both, the drive frequency and the resonance frequency can be referred to as “the first frequency”, and stating that the non-linear element is driven at “the first frequency” in this specification can apply to driving the non-linear element at a frequency which is close to either one, or both, the drive frequency and the resonance frequency.

More specifically, consider two quantum subsystems A and B. Subsystem A is a resonator 14 (e.g. linear oscillator) with Hamiltonian Ĥ_{A}=hωᵣâ^{†}â, where ωᵣ is its resonance frequency and a and at are the annihilation and creation operators, respectively, satisfying the bosonic commutation relation [â, â⁵⁵⁴ ]=1. Subsystem B is a non-linear element 12, described by a general Hamiltonian HB. The subsystems are coupled by a term that is a linear combination of â and â^{†}. In a very general form, this coupling term can be expressed as

$${\hat{H}}_{AB} = ℏ g ( {e}^{- i ϕ} {\hat{a}}^{†} + {e}^{i ϕ} \hat{a} ) ⊗ {\hat{O}}_{B} , \qquad ( 1 )$$

where, ℏ is the Planck constant, g is the coupling frequency, ϕ is any phase angle, and Ô_{B} is any hermitian quantum operator on system B.

We then consider a Lindblad master equation of the form

$$\frac{d \hat{ρ} ( t )}{dt} = - \frac{i}{ℏ} [ {\hat{H}}_{A} + {\hat{H}}_{B} + {\hat{H}}_{AB} + ℏ {ℰ}_{d} ( t ) sin ( {ω}_{d} t + {ϕ}_{d} ) ( {\hat{a}}^{†} + \hat{a} ) + {\hat{H}}_{cancel} ( t ) , \hat{ρ} ( t ) ] + {κ}_{↓} 𝒟 [ \hat{a} ] ( \hat{ρ} ( t ) ) + {κ}_{↑} 𝒟 [ {\hat{a}}^{†} ] ( \hat{ρ} ( t ) ) + {\sum }_{k = 1}^{M} {γ}_{k} 𝒟 [ {\hat{L}}_{B , k} ] ( \hat{ρ} ( t ) ) , \qquad ( 2 )$$

where [symbol] [X](\hat{ρ})=\hat{X}\hat{ρ}\hat{X}^{†}−(1/2)(\hat{X}^{†}\hat{X}\hat{ρ}+\hat{ρ}\hat{X}^{†}\hat{X}). Here, ε_{d}(t), ω_{d}, and ϕ_{d} are the time-dependent amplitude rate, frequency, and phase, respectively, of the drive 18 acting on the resonator 14. The incoherent rates for the resonator 14 are K_{⬇} and K_{⬆}, which describe the decay and absorption of excitations. Subsystem B, on the other hand, can have any number M of incoherent processes with rates γₖ and Lindblad operators \hat{L}_{B,k} where k=1, . . . , M.

The cancelation drive to be applied to subsystem B for stabilization can be described by the Hamiltonian

$${\hat{H}}_{cancel} ( t ) = - ℏ g [ α ( t ) {e}^{i ϕ} + α ( t ) * {e}^{- i ϕ} ] {\hat{O}}_{B} , \qquad ( 3 )$$

where α(t) is a complex-valued time-dependent function that satisfies the first-order differential equation

$$\frac{d α ( t )}{dt} = - ( i {ω}_{r} + \frac{{κ}_{↓}}{2} - \frac{{κ}_{↑}}{2} ) α ( t ) - i {ℰ}_{d} ( t ) sin ( {ω}_{d} t + {ϕ}_{d} ) . \qquad ( 4 )$$

The formal solution of Eq. (4) reads

$$α ( τ ) = α ( 0 ) {e}^{- ( i {ω}_{r} + ( {κ}_{↓} - {κ}_{↑} ) / 2 ) t} - i {\int }_{0}^{t} {ℰ}_{d} ( τ ) sin ( {ω}_{d} τ + {ϕ}_{d} ) {e}^{( i {ω}_{r} + ( {κ}_{↓} - {κ}_{↑} ) / 2 ) ( τ - t )} d τ . \qquad ( 5 )$$

If the resonator is initially empty, one can set the initial condition to zero, i.e., α(0)=0. The effect can be maximized for a given combination of phase and amplitude conditions. In this example, the cancelation drive specified by equations (3) and (5) depends on the resonance frequency of the resonator 14 and the drive frequency The effect is exact for this cancelation drive. In practice, the effect can be maximized for a given combination of frequency, phase, and amplitude conditions.

In some embodiments, the drive 18 can drive the resonator 14 directly. In other embodiments, the resonator 14 can be coupled to the non-linear element 12 and to a Purcell filter 20. The method can involve the drive 18 driving the Purcell filter 20, to which the resonator 14 responds at one or more frequencies; and driving the non-linear element 12 at one or more of the one or more frequency at which the resonator 14 responds, in which case driving the resonator at a first frequency can mean driving the resonator via driving the Purcell filter at a first frequency to which the resonator responds. The resonator may further respond at a second frequency to said driving the Purcell filter, and said driving the non-linear element can be further performed at the second frequency. In some embodiments, additional non-linear elements may be connected to the resonator 14.

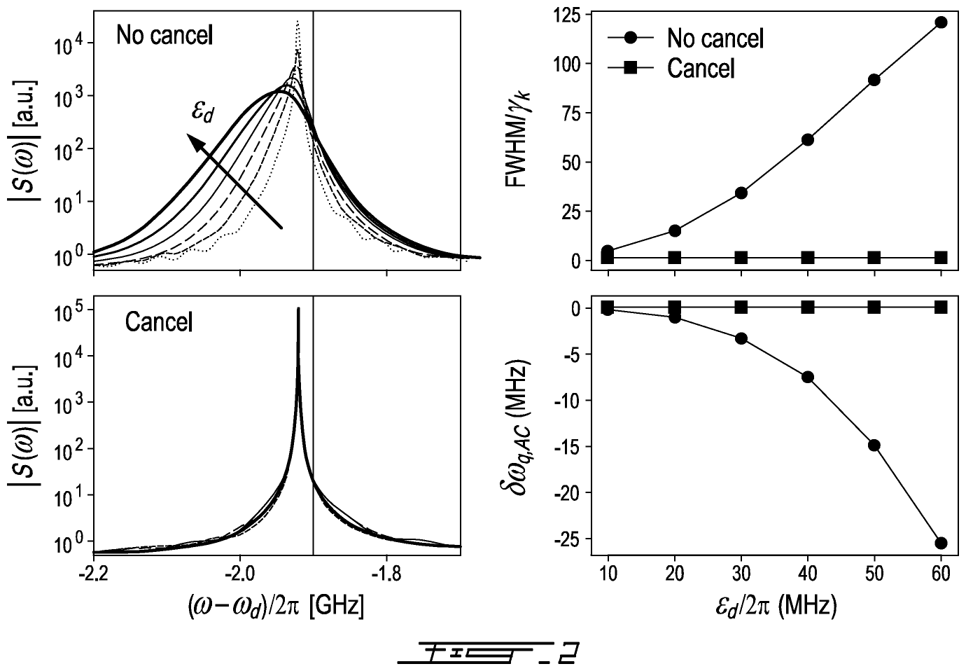

Numerical simulations are presented in FIG. 2. The two panels on the left show the spectral density S(ω) [in arbitrary units] of the non-linear element 12 (embodied here as a two-level system qubit as an example, being it understood that in alternate embodiments, a qubit may be embodied as a system having more than two levels) coupled to the resonator 14 for different values of the drive's amplitude (ε_{d}) on the resonator 14. The arrow in the top-left panel indicates the sense in which the different curves move as the drive amplitude is increased. Two scenarios are compared: “No cancel” refers to the case where there is no cancelation drive on the qubit, and “Cancel” refers to the case where we apply the cancelation drive to the qubit. The shift in the frequency peak of the spectral density S(ω) corresponds to the frequency AC Stark shift, extracted from the figures on the left panels and plotted for the two scenarios on the bottom-right panel, while the growth in linewidth (or spectral width) of the spectral density corresponds to the AC Stark-induced dephasing and is plotted on the top-right panel. We can see that, when the cancelation drive is being applied (ON), there is no AC Stark frequency shift nor AC Stark-induced dephasing, which can be beneficial in some embodiments.

Driving the non-linear element 12 in this manner can cause the effect of virtually presenting the non-linear element 12 with an empty resonator 14, independently of an actual loading of the resonator, which can have various uses in a variety of contexts. The effect can be more pronounced when the driving frequency(ies) of the non-linear element more closely match the response frequency(ies) of the resonator 14, and when respecting some amplitude and phase conditions as will be explained below, but some degree of imprecision can be tolerated and in some embodiments, the effect can be detectable when the driving frequency(ies) of the non-linear element is (are) within 10 resonator linewidths, within 5 resonator linewidths, or within 2 resonator linewidths of the response frequency(ies) of the resonator. In other words, when exposing the resonator 14 to a coherent wave to do an operation such as controlling, manipulating, protecting or measuring on the quantum system 10, you also expose the non-linear element 12 to a coherent wave.

In practice, the resonator 14 can respond at more than one frequency simultaneously. In particular, when driving the resonator 14 at a given drive frequency, the resonator 14 can respond both at its resonance frequency and at the first drive frequency (ωᵣ and ω_{d}). If the resonance frequency and the first drive frequency are significantly different from one another, such as more than 10 resonator linewidths apart for instance, best results may be obtained by driving the non-linear element 12 at both the resonance frequency and the drive frequency, within a certain degree of precision, whereas if the first drive frequency is close to the resonance frequency, driving the non-linear element 12 at a single frequency which is also close to these frequencies can provide satisfactory results. Accordingly, while in theory, best results can be achieved when the non-linear element 12 is driven at both frequencies at which the resonator 14 actually responds to the first driving, in practice, in many cases, simply driving the non-linear element 12 and the resonator 14 at the same frequency will provide suitable results.

The canceling drive can work best when performed at a given combination of phase and amplitude conditions that most closely follow equations (3) and (5). In practice, suitable phase and amplitude conditions can be determined for a given quantum system by calibration.

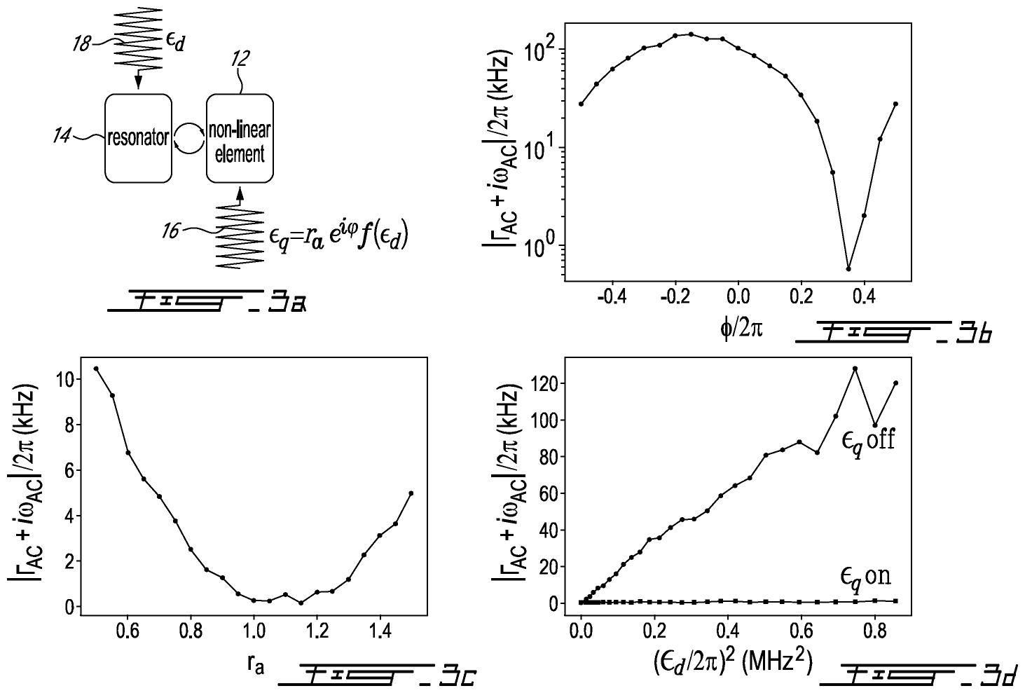

FIG. 3 presents a first example of a calibration technique. a) is a schematic representation of the technique and b)-d) are experimental results. In this technique, a measurement of the AC Stark effect induced by the first drive 18 (driving the resonator 14) is made. The measurement can be performed by a Ramsey-like experiment for instance where a gate (such as a X or pi/2 gate for a qubit) creating a superposed state is performed on the non-linear element 12, followed by a waiting time where the first drive 18 (and cancelation drive 16) is applied and finally, another identical (or similar) gate is applied on the non-linear element 12 before measuring the state of the non-linear element 12. Doing this measurement with sweeping the waiting time for example, one can extract the AC Stark induced dephasing Γ_{AX} and AC Stark induced frequency shift ω_{AC}. These AC Stark measurements can be performed for different phases of the cancelation drive (as illustrated in b)). A phase minimizing the induced Stark effect (y-axis) can be selected. Then, the same process can be performed for the amplitude of the canceling drive (as illustrated in c)). The processes illustrated in b) and c) can be repeated iteratively until a satisfactory set (phase φ, amplitude rₐ) is considered to have been found. d) presents a comparison of the AC Stark effect with (ε_{q}on) and without (ε_{q}off) the canceling drive.

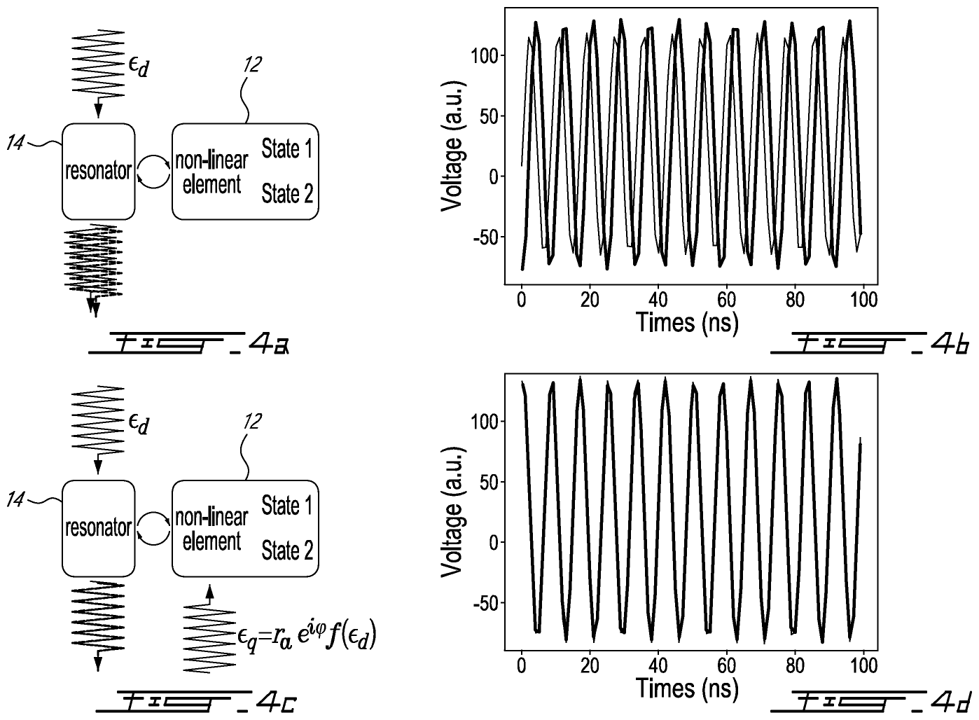

FIG. 4 presents a second example of a calibration technique. In this technique the non-linear element 12 does not need to be prepared in a superposed state, but rather in at least two different quantum states. First, the outgoing field of the resonator 14 (the field transmitted or reflected from the resonator 14 by the first drive) is acquired. Depending on the state of the non-linear element 12, the outgoing field phase and amplitude will be different (as illustrated in a) and demonstrated experimentally in b)). By adding the canceling drive, the outgoing field becomes independent of the state of the non-linear element (as illustrated in c) and demonstrated experimentally in d). The calibration of phase and amplitude of the canceling drive can then be performed as follows. First the phase is calibrated by minimizing the time-integrated norm of the difference between the outgoing fields acquired for two different state initializations of the non-linear element. Second, the process is repeated but now for the amplitude of the canceling drive. These two steps can be repeated until satisfactory calibration is deemed to be achieved.

Accordingly, in some embodiments, choosing the phase offset and amplitude factors of the non-linear element drive can involve 1) measuring the non-linear element frequency shift (compared to the undriven case) and/or the dephasing rate of the non-linear element (for instance using Ramsey interferometry) for several phase offsets; 2) choosing the phase offset as one that suitably limits the frequency shift, the dephasing rate, or the sum of their square; 3) measuring the non-linear element frequency shift (compared to the undriven case) and/or the dephasing rate of the non-linear element (for instance using Ramsey interferometry) for several amplitude factors; and 4) choosing the amplitude factor as one that minimizes the frequency shift, or the dephasing rate or the sum of their square.

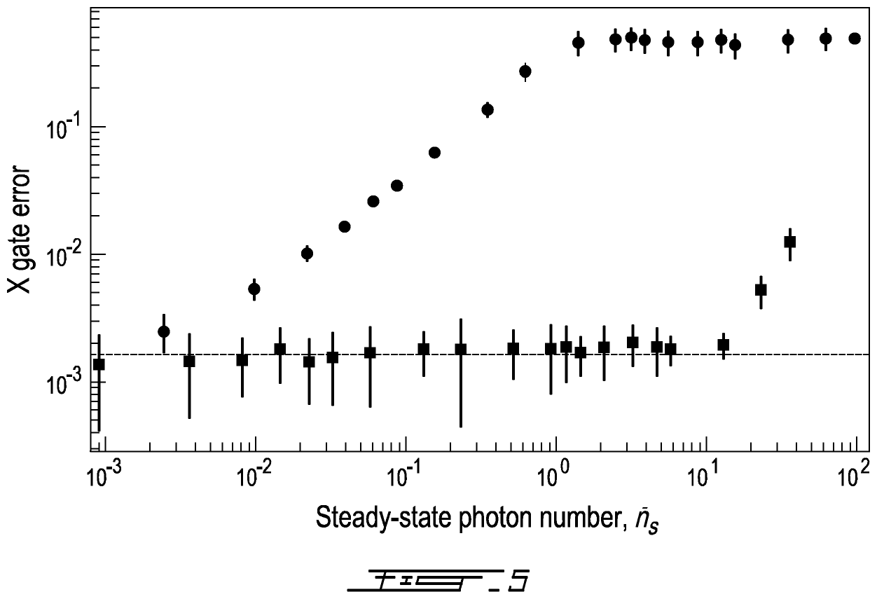

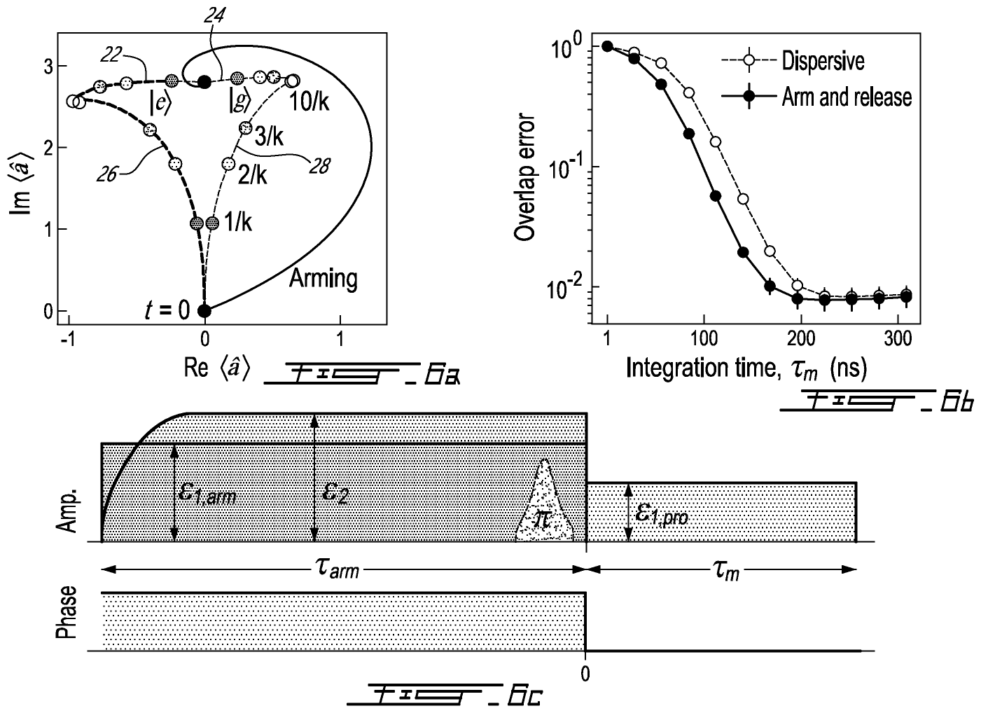

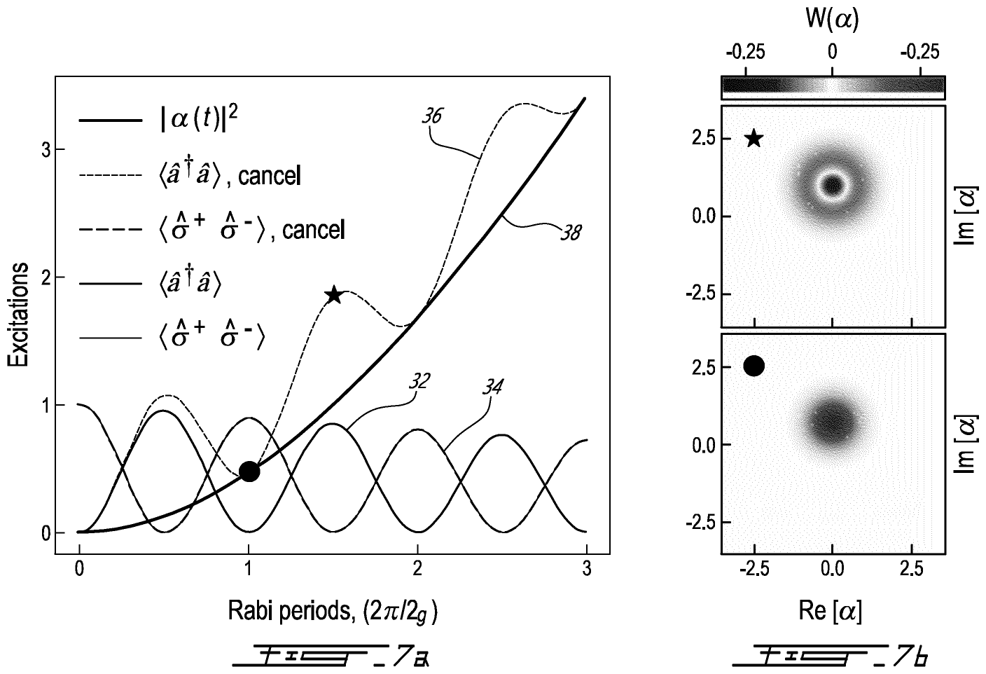

FIG. 5 presents an example of experimentally controlling the non-linear element while the resonator is loaded and the cancelation drive is being applied. Similarly to FIG. 6 and FIG. 7, the experimental example is conducted using a superconducting circuit architecture. The graph shows the experimentally determined error of an X gate on a transmon as a function of the average number of photons in the loaded resonator. When the cancelation drive is not being applied (circles), the gate rapidly deteriorates as a function of the average number of photons. When the cancelation drive is being applied (squares), the gate error is maintained for up to more than ten photons in the resonator 14. The line indicates the theoretical expectation of the gate error using the cancelation drive. These results demonstrate that it is possible to perform logical operations in the non-linear element 12 without inducing errors due to the resonator 14 being loaded as long as the cancelation drive is being applied. This can, for example, reduce the time required to readout the non-linear element 12 because the loading time does not factor in the readout time if gates can be applied on the non-linear element 12 during the resonator 14 loading.

FIG. 6 presents an example of qubit readout acceleration employing the introduced method. First, the resonator 14 is driven for a period of time Tarm where it becomes loaded (or “armed”), while simultaneously the cancelation drive is applied on the transmon. Second, the cancelation drive is turned off and a for a time τₘ the output field of the resonator 14 is measured, which conveys information about the transmon state. This method is here named “arm-and-release”. Panel c) shows the phase of the resonator drive as well as the amplitudes of the resonator 14 and cancelation drives as a function of time, as employed in the experimental demonstration. Panel a) shows numerical simulation of the time evolution of the average resonator field in phase space when it is initially loaded (“arming” line) and then the cancelation is turned off, leading to the two distinct evolutions (22 and 24) depending on the state of the transmon (ground state |g> or excited state |e>, respectively). This is compared to the case of standard dispersive readout (26 and 28). The colored dots indicate different instants of time in units of the resonator lifetime 1/κ, showing that with the initial loading of the resonator the phase-space trajectories separate faster in the case that the cancelation drive is used to initially load the resonator 14. The experimental demonstration of reduction in measurement time provided by the arm-and-release method approach is illustrated in panel b), which shows the measurement error versus integration time for the arm-and-release approach (full line) and the standard dispersive readout (dashed line) obtained using the superconducting circuit device.

FIG. 7 shows numerical simulations of non-Gaussian state preparation in the resonator 14 by employing a cancelation drive method. Panel a) shows the Rabi oscillations between a qubit and damped resonator in the resonant regime. A comparison is drawn between standard Rabi oscillations (lines 32 and 34) and the Rabi oscillations when the resonator is driven simultaneously to the cancelation drive being applied (lines 34 and 36). In the latter case, the resonator field oscillates on top of the loaded coherent state α(t) (line 38). Panel b) shows the resonator field's Wigner distribution at 3/2 (top) and 1 (bottom) Rabi periods. The top panel shows that this protocol can be employed to prepare, for example, the non-Gaussian state |g>⊗\hat{D}(α)|1> corresponding to the qubit in the ground state and the resonator in a displaced n=1 Fock state. This is but one example of quantum state preparation using the cancelation drive method. While FIGS. 2 to 6 may relate to examples where the non-linear element 12 and the resonator 14 have different frequencies, FIG. 7 shows that the concept can also apply to some embodiments where the non-linear element 12 and the resonator 14 have the same frequency. In summary, in one embodiment, the resonator 14 and the non-linear element 12 can be driven at same frequency, and on top of that, the non-linear element 12 can be initialized in a predetermined quantum state. The system can be left to evolve in time, and at a predetermined time, we can observe (measure) a quantum state in the resonator 14 which is non-Gaussian (really quantum, not classical). Such an application can be useful in quantum sensing, quantum metrology and quantum error correction, to name some examples.

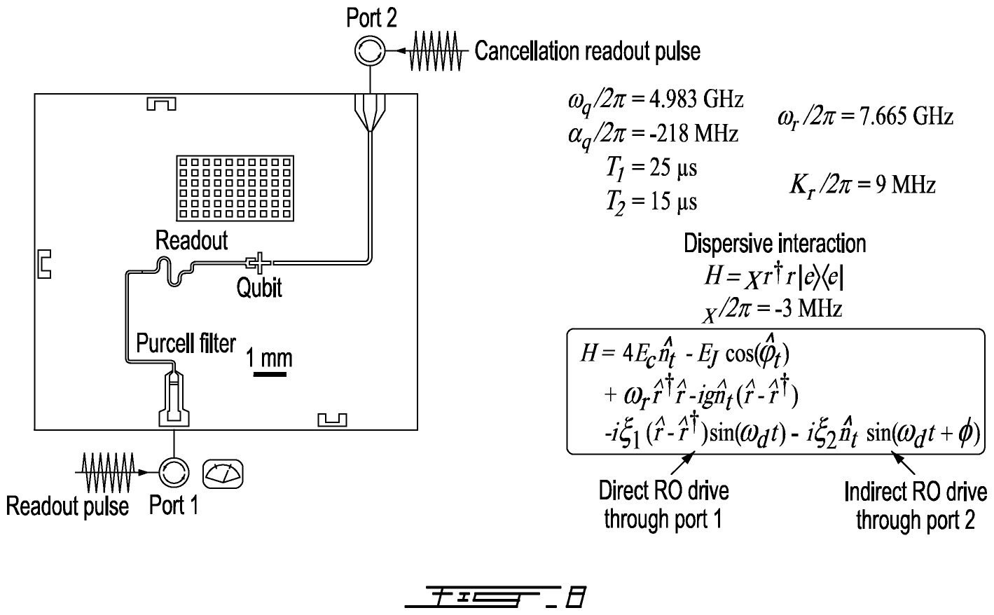

FIG. 8 presents an example sample and setup in which the cancelation drive effect has been measured. The equations specific to this setup are presented on the right-hand side. It will be understood that this is but one very specific example presented here as a demonstration of operability, but various different embodiments and implementations are possible.

Indeed, depending on the embodiment, the resonator can be embodied as electromagnetic, electromechanical, magnonic or mechanical oscillator, can be linear or non-linear, such as by becoming non-linear due to coupling to a non-linear system. In many practical implementations, the resonator will be linear. Similarly, depending on the embodiment, the non-linear element can be a non-linear resonator, oscillator, cavity (the latter three can be synonyms depending on context) or a multi-level qubit (such as real atoms or artificial atoms like a transmon or fluxonium qubit). Typically, the non-linear element will have discrete energy levels (e.g., qubit). “Coupling” is typically linear, such as capacitive or inductive, but in some cases the coupling may be more complex and not necessarily linear. Coupling can be implemented via a distinct coupling element but can alternatively be incorporated to one of the elements of the system, such as the resonator for instance. Indeed, in many practical applications, capacitive coupling can be achieved via the presence of metallic components in the proximity of elements of the system. Coupling can typically be dispersive, but not necessarily in all embodiments. Dispersiveness is a concept of relative frequency between the resonator and the non-linear element and can also be a function of the strength of the coupling. “Driving” involves exposing the element of the system to a coherent wave. Typically, the coherent wave would be an electromagnetic wave, but in some embodiments, the coherent wave could be generated by other electromagnetic means such as an electric field, a magnetic field, DC, AC, or even with other means such as acoustic waves.

Amongst example applications to the “canceling drive” are i) avoiding noise such as cross-talk between non-linear elements such as qubits when an operation is being performed on one of the non-linear elements (or avoiding an AC Stark induced frequency shift and dephasing), ii) performing a logical operation on at least one element, iii) non-linear element readout, iii) non-linear element readout, and iv) preparation of non-Gaussian states in the resonator.

In the case of a non-linear element readout, the measuring can involve modifying at least one of the driving of the resonator or of the driving of the non-linear element, typically the resonator. For quantum computers for instance, fast and reliable operations is a constant concern. Logical operations on qubits in some architectures is much faster and reliable than readout, and therefore readout speed and/or reliability (one is often improved at the trade-off of the other) can be considered a significant concern. Readout is often performed via a resonator with excitations in preparation for readout. Hence, there can be an advantage to a technique which allows to load the resonator. Driving the non-linear element roughly at the same frequency than driving the resonator can be a way of loading the resonator, without affecting the non-linear element, in preparation for readout.

Let us look at several example applications in greater detail:

A first potential motivation to apply the canceling drive is to cancel AC Stark frequency shift and/or AC Stark-induced dephasing (the two latter phenomena going hand in hand). Inherently, when the non-linear element is virtually presented an empty resonator, there is no AC Stark frequency shift nor AC Stark-induced dephasing, which can be a reason to perform the method in and of itself.

As an example, when performing a logical operation, the resonator may be driven (loaded). Once the operation has ended the drive on the non-linear element can be applied to cancel AC stark frequency shift and AC Stark-induced dephasing while the resonator empties. In such an embodiment, the resonator can empty upon a reset for example, which can involve changing the sign of the resonator drive, and the cancelation drive on the non-linear element can be applied when driving the resonator with the sign of the drive changed.

As another example, in the context of multiple non-linear elements coupled to a resonator, an instance arises wherein a logical operation is executed in one or more of these non-linear elements. In such cases, it becomes beneficial to use a cancelation drive on any of the non-linear elements that are coupled to the resonator but are not directly involved in the logical operation.

As a further example when doing logical operations where the resonator is loaded with excitations, the AC Stark frequency shift and AC Stark-induced dephasing could be canceled in some periods of time during the operation in a manner which might improve the logical operations for some reason or another, or the canceling drive might be applied to get faster and higher fidelity logical operations, for reasons unrelated to AC stark shift and/or AC Stark-induced dephasing. Experimental trials and testing may indeed lead to embodiments where this could be useful.

Another potential motivation to apply the canceling drive is when performing readout. For instance, the resonator may be pre-loaded including driving the resonator while sending the canceling drive to the non-linear element, stopping the cancelation drive while maintaining the drive on the resonator. The coherent waves emitted and/or reflected from the resonator carry information about the state of the non-linear element and reading (measuring properties of) those coherent waves can be performed while the cancelation drive is interrupted but while still driving the resonator. Such a technique may be helpful in improving the speed of readout when performing an operation on the non-linear element during the loading of the resonator (hence the “pre” in the expression pre-loading). This is demonstrated, for instance, in the simulations and experimental results shown in FIG. 6.

It may be possible to perform readout with a larger number of excitations in the resonator in a way that would not be feasible without the canceling drive. Indeed, in some cases, when a number of excitations in the resonator exceeds a certain limit, the non-linear element may be affected in an undesirable manner (e.g. many quantum states are occupied) degrading the quality of readout. It may be possible that such undesired effects would be prevented by the canceling drive in some embodiments. Such undesirable effects may be known to happen when a specific number of excitations is in the resonator, in which case it may be relevant to apply the canceling drive at least during the period when the specific number of excitations is present in the resonator, and then discontinue the canceling drive when the number of excitations in the resonator is different from that specific number, such as greater or lesser.

Multiple non-linear elements may use a single resonator for readout, and a step of reading out one of the non-linear elements via the resonator may include applying the canceling drive to every other non-linear element coupled to the resonator, such that the other non-linear elements are not affected by the readout. In embodiments where such a technique could apply, the size of a quantum computing chip may be reduced for instance, which could be advantageous.

Alternatively, the resonator could be pre-loaded with excitations before performing a logical operation on one or more non-linear element coupled. The canceling drive then be stopped, and then changing or maintaining the drive on the resonator to perform the logical gate on the non-linear element. For instance, in an embodiment having resonator-induced phase (RIP) gates, a two-qubit operation involves driving the resonator at a frequency which is at several resonator linewidths away from the natural resonance frequency of the resonator. This drive is turned on and off (aka opened and closed) slowly (adiabatically). In such a context, the resonator to which two or more qubits are connected could be pre-loaded, during which other operations could be performed on the qubits (e.g. one qubit operations). When ready to apply the RIP gate, the drive on the resonator and/or the cancelation tones on the qubits can be interrupted or modified. Indeed, a RIP gate can be faster when there are more excitations in the resonator, but loading the resonator with excitations can take time. By pre-loading as suggested above, it may be possible to apply the gate at a higher number of excitations, but at a lower penalty of time.

In yet another example, the cancelation drive could be applied at some point during some period of time of the logical operation on the non-linear element rather than just in the pre-loading of the resonator.

A quantum system such as presented above may be used in a wide variety of different applications and implemented in a wide variety of different potential architectures. In one application, the quantum system can be a routing system, having a waveguide/transmission line connected to the coupler, the system acting as a single-photon switch. In another application, the quantum system can be embodied as a gate-based quantum computer, such as a cross-resonance frequency-fixed architecture showing small detunings, parametric couplers architectures, and frequency-tunable qubits architectures which can use dynamical decoupling and be implemented with longitudinal drive. Example architectures include superconducting circuits, and potentially other architectures such as semiconducting quantum dots, impurity-based architectures, mechanical element architectures, phonon-based architectures, photonic circuits, spin-based architectures, trapped ions, cold atoms, semiconducting, and hybrid architectures, such as hybrid photonic circuits.

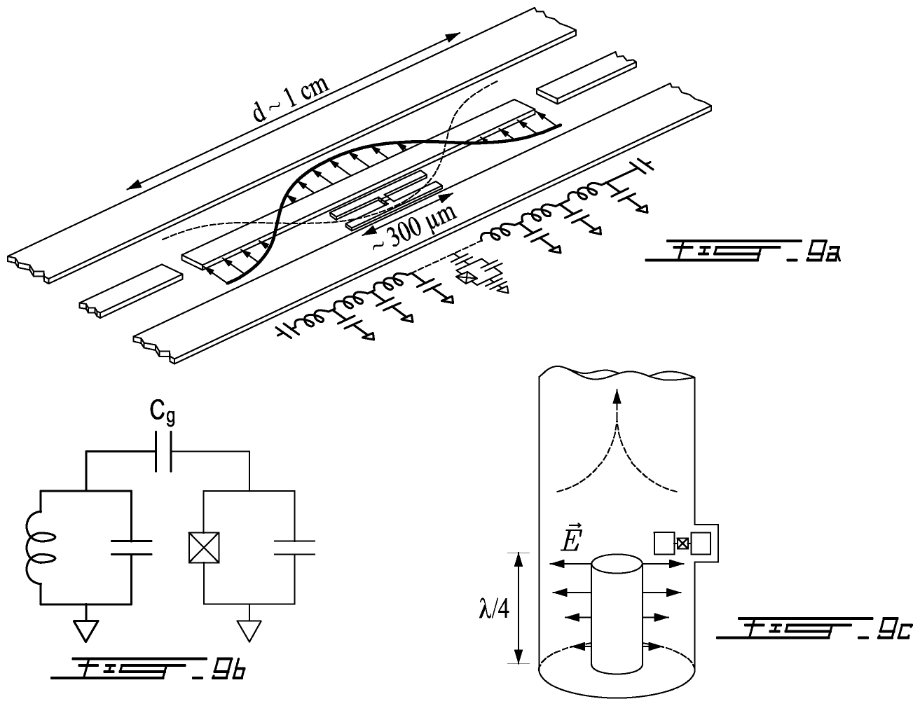

FIG. 9 presents an example implementation scheme with superconducting qubits and electromagnetic resonators. More specifically a schematic representation of a transmon qubit (green) coupled to a) a 1D transmission-line resonator, b) a lumped-element LC circuit, and (c) a 3D coaxial cavity.

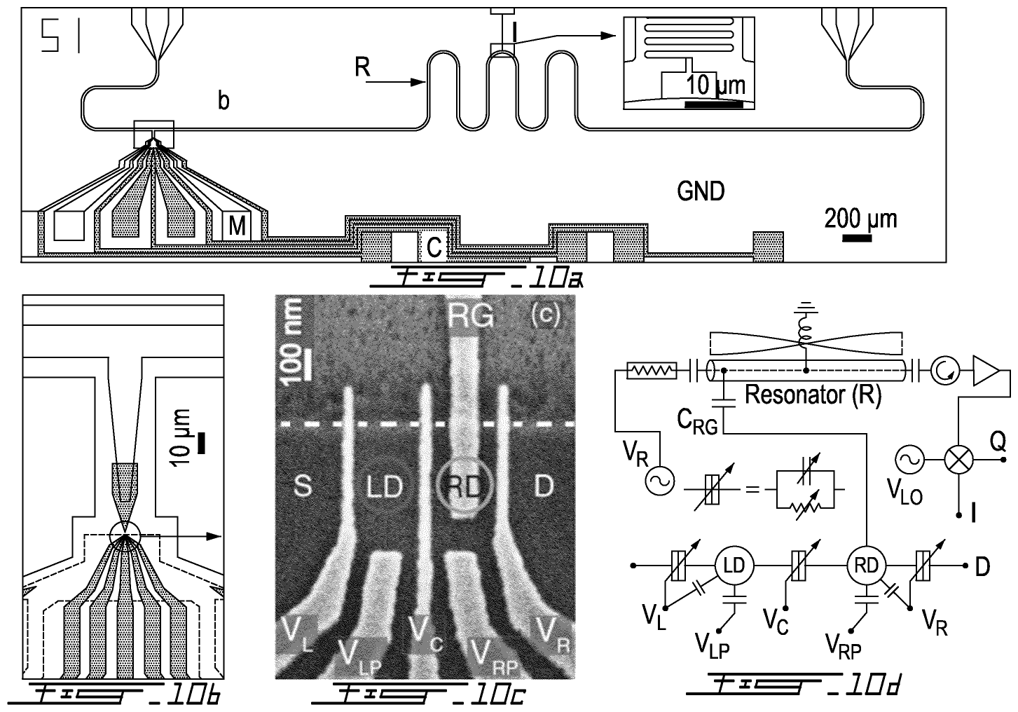

FIG. 10 presents an example implementation scheme with spin qubits embodied as quantum dots in a semiconductor, and electromagnetic resonators. More specifically, a) is an optical micrograph of the microwave resonator (R), with integrated double quantum dot, Ohmic contacts (M), top gates (C), ground plane (GND), and on-chip inductor (I). The inset is a magnified view of inductor (I). b) is an enlarged view of the device near the double quantum dot. The mesa edge is highlighted with a dashed line. c) shows scanning electron micrograph of the gate structure defining the double quantum dot (LD, RD). RG marks the gate connected to the resonator, V_{L}, V_{LP}, V_{C}, V_{RP}, V_{R} label top gate voltages, and S, D, the 2DEG source and drain. d) is an electric circuit representation of the double quantum dot coupled to the resonator. The double quantum dot is tuned with voltages V_{L}, V_{LP}, V_{C}, V_{RP}, V_{R} and connected to the resonator via the capacitance C_{RG}. The resonator is driven with a microwave signal at frequency v_{R}. The transmitted signal passes through a circulator, is amplified and mixed with the local oscillator v_{LO} to obtain the field quadratures I and Q.

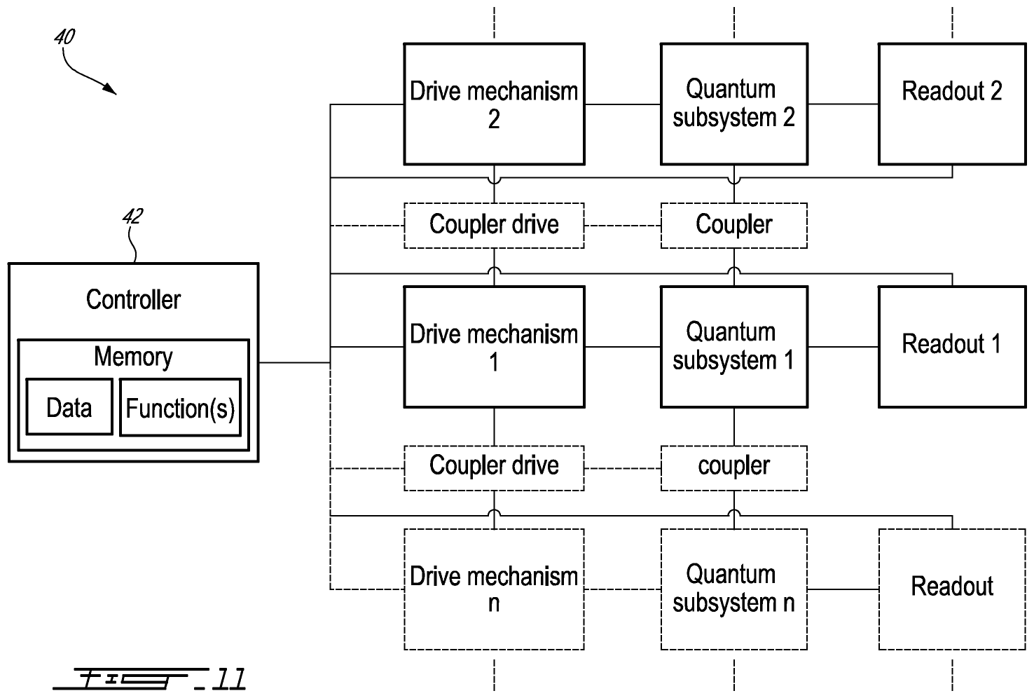

FIG. 11 presents an example of a quantum system which includes a plurality of quantum subsystems. In the context of quantum computing, the quantum subsystems are used to host logical states and can be referred to as qubits, and the quantum system can be referred to as a quantum processor 40. The nature of the qubits, the means by which logical states are hosted in the qubits, and the means by which operations are performed between the qubits depend on the choice of architecture. There are several competing architectures, including quantum annealers and gate-based quantum processors. However, independently of the architecture, a typical quantum processor will have at least two qubits interconnected to one another in a manner to allow them to interact in an operation which will typically involve entanglement. Most qubits embodied as bosonic-based quantum processors, for example, involve some form of resonator, and the logical states will be driven in the qubits using some form of driving hardware which can control a number of bosons in the qubits. The driving hardware is controlled by a component which will be referred to herein as a controller for simplicity, and which typically includes a classical computer. The qubits are typically refrigerated to very low temperatures and insulated from the environment. In a quantum annealing type architecture, the quantum subsystems can be directly operably interconnected to one another. In gate-based quantum computing, the quantum subsystems are typically interconnected to one another via couplers which are used to selectively control the interactions between the quantum subsystems. The couplers are also quantum subsystems operable to host states via which the logical states of the two or more connecting quantum subsystems are to interact, and are also driven by driving hardware which can be controlled by the same controller for convenience. Readout ports can be provided via which the state of the qubits can be read, an operation which can be said to involve “measuring”.

Components of the system presented in FIG. 1 can be implemented as drive mechanism 1, quantum subsystem 1, and readout 1, for example. More specifically, drive 16 can be implemented as drive mechanism 1, non-linear element 12 can be implemented as quantum subsystem 1. Readout 1 could include the resonator 14, the resonator drive 18, one or more port and associated waveguide, for example.

The controller 42 can be expected to include a memory which can include functions in the form of computer readable instructions driving the operation of the controller 42, and data. The functions can include a “driving program”, for instance, which, in the case of gate-based quantum computing, can include a sequence of gates, typically referred to as a quantum circuit, stored as data in the memory. When the states of the qubits are read, the measured values can be stored in the form of data, for instance.

The controller can be embodied as a computer. It will be understood that the expression “computer” as used herein is not to be interpreted in a limiting manner. It is rather used in a broad sense to generally refer to the combination of some form of one or more processing units and some form of memory system accessible by the processing unit(s). The memory system can be of the non-transitory type. The use of the expression “computer” in its singular form as used herein includes within its scope the combination of a two or more computers working collaboratively to perform a given function. Moreover, the expression “computer” as used herein includes within its scope the use of partial capabilities of a given processing unit. Example computers include supercomputers, desktop, laptop, smartphone, smart watch, less elaborated controller devices, etc.

A processing unit can be embodied in the form of a general-purpose micro-processor or microcontroller, a digital signal processing (DSP) processor, an integrated circuit, a field programmable gate array (FPGA), a reconfigurable processor, a programmable read-only memory (PROM), to name a few examples.

The memory system can include a suitable combination of any suitable type of computer-readable memory located either internally, externally, and accessible by the processor in a wired or wireless manner, either directly or over a network such as the Internet. A computer-readable memory can be embodied in the form of random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) to name a few examples.

A computer can have one or more input/output (I/O) interface to allow communication with a human user and/or with another computer via an associated input, output, or input/output device such as a keyboard, a mouse, a touchscreen, an antenna, a port, etc. Each I/O interface can enable the computer to communicate and/or exchange data with other components, to access and connect to network resources, to serve applications, and/or perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, Bluetooth, WiMAX), SS7 signaling network, fixed line, local area network, wide area network, to name a few examples.

It will be understood that a computer can perform functions or processes via hardware or a combination of both hardware and software. For example, hardware can include logic gates included as part of a silicon chip of a processor. Software (e.g., application, process) can be in the form of data such as computer-readable instructions stored in a non-transitory computer-readable memory accessible by one or more processing units. With respect to a computer or a processing unit, the expression “configured to” relates to the presence of hardware or a combination of hardware and software which is operable to perform the associated functions. Different elements of a computer, such as processor and/or memory, can be local, or in part or in whole remote and/or distributed and/or virtual.

The methods and systems of the present disclosure may be implemented in a high-level procedural or object-oriented programming or scripting language, or a combination thereof, to communicate with or assist in the operation of a computer system, for example the controller. Alternatively, the methods and systems described herein may be implemented in assembly or machine language. The language may be a compiled or interpreted language. Program code for implementing the methods and systems described herein may be stored on a storage media or a device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein. Embodiments of the methods and systems described herein may also be considered to be implemented by way of a non-transitory computer-readable storage medium having a computer program stored thereon. The computer program may comprise computer-readable instructions which cause a computer, or more specifically the processing unit of the computing device, to operate in a specific and predefined manner to perform the functions described herein.

Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments. The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

As can be understood, the examples described above and illustrated are intended to be exemplary only. The scope is indicated by the appended claims.

1. A method of operating a quantum system having a non-linear element coupled to a resonator, the non-linear element having a quantum state changeable between a plurality of quantum states and the resonator having a resonance frequency, the method comprising:
driving the resonator;
the resonator responding at a first frequency to said driving the resonator; and
simultaneously to said driving the resonator, driving the non-linear element at the first frequency.

2. The method of claim 1 wherein the resonance frequency shifts by a difference of frequency values, the difference of frequency values depending on the quantum state of the non-linear element.

3. The method of claim 1 wherein said driving the resonator is performed at the first frequency.

4. The method of claim 3 wherein the resonator further responds at a second frequency to said driving the resonator, and said driving the non-linear element is further performed at the second frequency, wherein the second frequency is the resonance frequency.

5. The method of claim 4 wherein the non-linear element is a first non-linear element, further comprising a second non-linear element coupled to the resonator, said driving the non-linear element at the first frequency and the second frequency including driving the first non-linear element and the second non-linear element at the first frequency and the second frequency, the first non-linear element and the second non-linear element being in a joint quantum state.

6. The method of claim 4 wherein said resonator further responds at a third frequency, and said driving the non-linear element is further performed at the third frequency.

7. The method of claim 1 wherein the non-linear element is a first non-linear element, further comprising a second non-linear element coupled to the resonator, said driving the non-linear element at the first frequency including driving the first non-linear element and the second non-linear element at the first frequency, the quantum state of the first non-linear element being a joint quantum state of the first non-linear element and the second non-linear element.

8. The method of claim 1 wherein the non-linear element is a first non-linear element, the quantum system further comprising a second non-linear element wherein said driving the resonator and driving the first non-linear element at the first frequency includes canceling cross-talk between the first non-linear element and the second non-linear element while performing an operation on one of the first and the second non-linear element.

9. The method of claim 1 wherein the first frequency is within 10 resonator linewidths of the resonance frequency.

10. The method of claim 1 wherein the resonator is coupled to a non-linear element and to a Purcell filter, said driving the resonator at a first frequency means driving the resonator via driving the Purcell filter at a first frequency to which the resonator responds, the resonator further responds at a second frequency to said driving the Purcell filter, and said driving the non-linear element is further performed at the second frequency, wherein the first frequency is a frequency of said driving the Purcell filter.

11. The method of claim 1 further comprising measuring which quantum state the non-linear element is in, said measuring including modifying at least one of the driving the resonator and the driving the non-linear element.

12. The method of claim 11 wherein said measuring includes modifying the driving the resonator.

13. The method of claim 1 wherein the resonator has a quantum state independent of the quantum state of the non-linear element, further comprising, simultaneously to said driving the resonator and driving the non-linear element, modifying at least one of the quantum state of the non-linear element and the quantum state of the resonator, said modifying including driving one of the non-linear element and the resonator at a second frequency, wherein the driving the non-linear element includes loading the quantum state of the resonator.

14. The method of claim 13, further comprising, subsequently to said loading the quantum state of the resonator, measuring which quantum state the non-linear element is in, said measuring including modifying at least one of the driving the resonator and the driving the non-linear element.

15. The method of claim 1 wherein simultaneously to said driving the resonator and driving the non-linear element at the first frequency, modifying at least one of the quantum state of the non-linear element and the quantum state of the resonator, said modifying including driving one of the non-linear element and the resonator at a second frequency.

16. The method of claim 1 wherein said driving the non-linear element at the first frequency includes canceling a Stark shift and presenting the resonator to the non-linear element as being empty.

17. The method of claim 1 wherein said driving the non-linear element at the first frequency includes canceling an AC Stark shift and an AC Stark-induced dephasing and presenting the resonator to the non-linear element as being empty.

18. The method of claim 1 including dissociating a frequency of the non-linear element from an energy of the resonator.

19. The method of claim 1, further comprising changing the quantum state of the non-linear element.

20. The method of claim 19 further comprising the resonance frequency of the resonator shifting by the difference of frequency values in response to the changing of the quantum state of the non-linear element.

21. The method of claim 1 wherein said driving the non-linear element is performed at a given phase offset and a given amplitude factor, further comprising measuring the non-linear element frequency shift and/or the dephasing rate of the non-linear element for several phase offsets; and measuring the non-linear element frequency shift and/or the dephasing rate of the non-linear element for several amplitude factors.

22. The method of claim 21 further comprising setting a phase offset and an amplitude factor minimizing one of an AC Stark shift, a dephasing rate, and a sum of the square of AC Stark shift and the dephasing rate.

23. The method of claim 1 wherein said operating includes at least one of controlling, manipulating, protecting and measuring one of the non-linear element and the resonator.
